(19) United States
(12) Patent Application Publication
(10) Pub. No.: US 2019/0177996 A1
(43) Pub. Date: Jun. 13, 2019

(54) OPEN EDGE STAND

(71) Applicant: Joseph Careri, Alliston (CA)

(72) Inventor: Joseph Careri, Alliston (CA)

(21) Appl. No.: 15/839,842

(22) Filed: Dec. 12, 2017

(51) Int. Cl. E04H 17/16; E06B 9/06; E04H 17/22

(52) U.S. Cl. CPC E04H 17/163; E04H 2017/1495; E04H 17/22; E06B 9/06

(57) ABSTRACT

A collapsible barrier includes a substantially rectangular sheet. The substantially rectangular sheet includes a first post and a second post pivotably connected with hinges. Feet with apertures configured to receive fasteners perpendicularly extend from the bottom of the first post and the second post. A first-bracing member and a second-bracing member respectively reinforce the first post and the second post in a perpendicularly oriented position with respect to each other. A metallic webbing integrated with the substantially rectangular sheet to provide suitable strength and load bearing capabilities. The substantially rectangular sheet includes a perpendicular lip along the vertical edges. The posts are configured to pivot the feet to align parallel with the substantially rectangular sheet. When the feet are aligned parallel with the substantially rectangular sheet the lip of the substantially rectangular sheet allows multiple collapsible barriers to be stacked. The collapsible barrier is useful for providing a portable barrier.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of barriers of existing art and more specifically relates to portable barriers.

### RELATED ART

Frequently workers must erect static barriers on the job. These barriers typically come in an assembly of parts. The parts generally include a large amount of posts, bracing members and framed barrier surfaces. Transporting and storing these barriers is a cumbersome task that exhausts labor workers and their budget. Generally, the individual parts must be bundled for transport. Large quantities of posts, bracing members, and barrier surfaces must be counted and bundled before transport. It is important that the exact number of individual parts is accounted for the assembly. Once transported to a worksite, these bundles are typically unloaded with a heavy machinery. Laborers must take company time and resources to double check the number of pieces. The pieces must then be assembled on the worksite, taking even more time. A suitable solution is desired.

U.S. Pat. No. 3,789,801 to J. Moreng relates to a portable, collapsible steeplechase hurdle or fence. The described portable, collapsible steeplechase hurdle or fence includes a barrier member of light weight, reinforced construction which is adapted to rest on the ground, at one longitudinal edge, in the erected condition and which is preferably curved in the direction toward the opposite or uppermost longitudinal edge, support legs pivoted in back of the barrier member to swing between erected positions, in which the legs extend downwardly from the uppermost edge of the barrier member for engagement with the ground, and stored positions in which the legs lie against the barrier member, and bracing link members pivotally connected to the barrier member and legs and being movable between extended and collapsed positions respectively corresponding to the erected and stored position of the legs, with such bracing link members being automatically retained in either their extended or collapsed positions for preventing inadvertent displacement of the legs from either their erected or stored positions, respectively.

### SUMMARY OF THE INVENTION

In view of the foregoing disadvantages inherent in the known portable barrier art, the present disclosure provides a novel collapsible barrier system and method. The general purpose of the present disclosure, which will be described subsequently in greater detail, is to provide an effective and efficient collapsible barrier system and method.

A collapsible barrier is disclosed herein. The collapsible barrier includes a substantially rectangular sheet. The substantially rectangular sheet includes an upper-horizontal edge, a lower-horizontal edge, a first-vertical edge and, a second-vertical edge. A metallic webbing is integrated with the substantially rectangular sheet to provide suitable strength and load bearing capabilities. A first post has a first-upper edge and a first-lower edge. The first post is disposed a first-distance from the first-vertical edge. A second post has a second-upper edge and a second-lower edge. The second post is disposed a second-distance from the second-vertical edge. A first foot extends the first-distance perpendicularly from the first-lower edge of the first post. A second foot extends the second-distance perpendicularly from the second-lower edge of the second post. The first-bracing member joins the first post to the first foot. A second-bracing member joins the second post to the second foot. At least one hinge mechanically couples the first post to the substantially rectangular sheet, and the second post to the substantially rectangular sheet. A first-normal plane extends a first-planar distance perpendicularly along the first-vertical edge. A second-normal plane extends a second-planar distance perpendicularly along the second-vertical edge. The first post and the second post are aligned parallel to the first-vertical edge and the second-vertical edge. The first-distance and the second-distance are substantially equal. The collapsible barrier is configured to be stacked.

According to another embodiment, a collapsible barrier installation is also disclosed herein. The collapsible barrier installation includes a providing a collapsible barrier as disclosed; unfolding the second foot pivotably with the second pole until the second foot is perpendicular to the substantially rectangular sheet; aligning apertures of the first foot and the second foot for mechanically affixing to a surface; and fastening the first foot and the second foot to a surface.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a collapsible barrier system and method, constructed and operative according to the teachings of the present disclosure.

FIG. 1 is a rear perspective view of the collapsible barrier during an ‘in-use’ condition, according to an embodiment of the disclosure.

FIG. 2 is a top view of the collapsible barrier of FIG. 1, according to an embodiment of the present disclosure.

FIG. 3 is a top view of the collapsible barrier of FIG. 1, according to an embodiment of the present disclosure.

FIG. 4 is a front view of the collapsible barrier of FIG. 1, according to an embodiment of the present disclosure.

FIG. 5 is a flow diagram illustrating a method of collapsible barrier installation, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to portable barriers and more particularly to a collapsible barrier as used to improve the efficiency of barriers.

Generally, the collapsible barrier includes a substantially rectangular sheet. The substantially rectangular sheet includes an upper-horizontal edge, a lower-horizontal edge, a first-vertical edge and, a second-vertical edge. The upper-horizontal edge and the lower-horizontal edge may be longer than the first-vertical edge and the second-vertical edge. The upper-horizontal edge and the lower-horizontal edge may be substantially equal and be approximately 10-feet. A toe-board may be disposed along the lower-horizontal edge. A metallic webbing is integrated with the substantially rectangular sheet to provide suitable strength and load bearing capabilities.

The collapsible barrier includes a first post having a first-upper edge and a first-lower edge. The first post is disposed a first-distance from the first-vertical edge. The first-distance may be approximately 1.5-feet. The collapsible barrier includes a second post having a second-upper edge and a second-lower edge. The second post is disposed a second-distance from the second-vertical edge. The second-distance may be approximately 1.5-feet. A first foot extends the first-distance perpendicularly from the first-lower edge of the first post. A second foot extends the second-distance perpendicularly from the second-lower edge of the second post. The first foot and the second foot may include apertures configured to receive fasteners for securing the first foot and the second foot to a surface.

A first-bracing member joins the first post to the first foot. A second-bracing member joins the second post to the second foot. At least one hinge mechanically couples the first post to the substantially rectangular sheet. The first post may be pivotably connected to the substantially rectangular sheet and configured to pivot axially toward the first-vertical edge. The first foot may be configured to fit parallel to the substantially rectangular sheet when the first post is pivoted about its axis outwardly towards the first-vertical edge. At least one hinge mechanically couples the second post to the substantially rectangular sheet. The second post may be pivotably connected to the substantially rectangular sheet and configured to pivot axially toward the second-vertical edge. The second foot may be configured to fit parallel to the substantially rectangular sheet when the second post is pivoted about its axis outwardly towards the second-vertical edge.

A first-normal plane extends a first-planar distance perpendicularly along the first-vertical edge. The first-planar distance may be sized such that the first-normal plane extends past the first foot when the first foot is aligned parallel to the substantially rectangular sheet. A second-normal plane extends a second-planar distance perpendicularly along the second-vertical edge. The second-planar distance may be sized such that the second-normal plane extends past the second foot when the second foot is aligned parallel to the substantially rectangular sheet. The first post and the second post are aligned parallel to the first-vertical edge and the second-vertical edge. The first-distance and the second-distance are substantially equal. The collapsible barrier may be made of light-weight material and is configured to be stacked. Those with ordinary skill in the art will now appreciate that upon reading this specification and by their understanding the art of collapsible barriers as described herein, methods of collapsible barrier installation will be understood by those knowledgeable in such art.

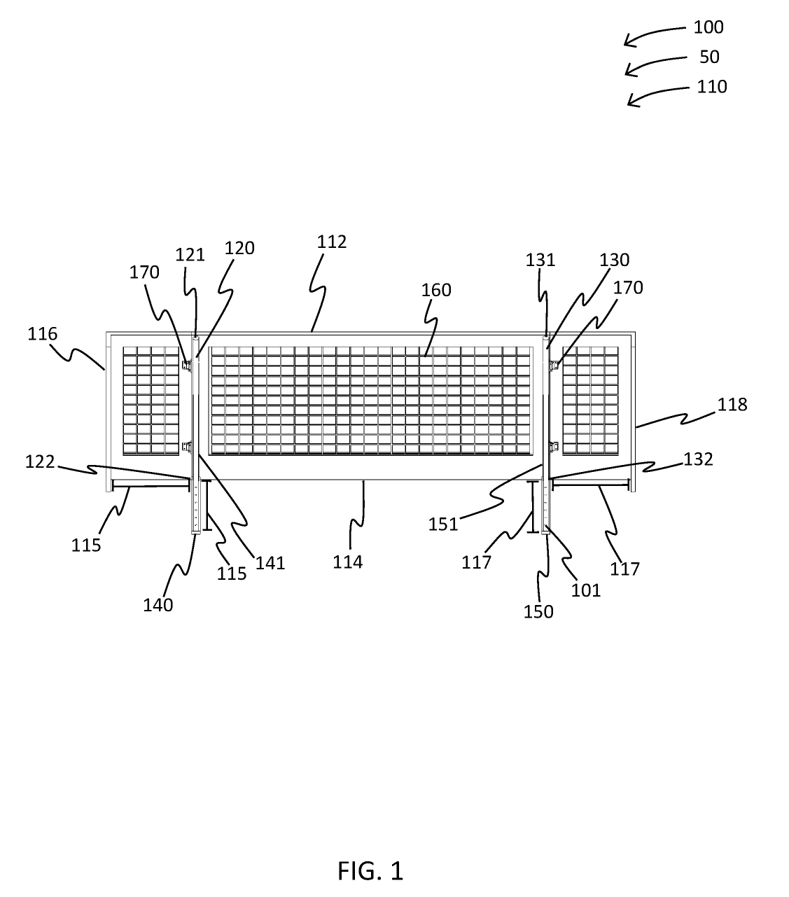

Referring now more specifically to the drawings by numerals of reference, there is shown in FIGS. 1-4, various views of a collapsible barrier 100.

FIG. 1 shows a collapsible barrier 100 during an ‘in-use’ condition 50, according to an embodiment of the present disclosure. Here, the collapsible barrier 100 may be beneficial for erecting a portable barrier. As illustrated, the collapsible barrier 100 may include a substantially rectangular sheet 110, the substantially rectangular sheet 110 comprising an upper-horizontal edge 112, a lower-horizontal edge 114, a first-vertical edge 116, and a second-vertical edge 118. A metallic webbing 160 is integrated with the substantially rectangular sheet 110 to provide suitable strength and load bearing capabilities.

A first post 120 has a first-upper edge 121 and a first-lower edge 122; the first post 120 is disposed a first-distance 115 from the first-vertical edge 116. A second post 130 has a second-upper edge 131 and a second-lower edge 132; the second post 130 is disposed a second-distance 117 from the second-vertical edge 118. A first foot 140 extends the first-distance 115 perpendicularly from the first-lower edge 122 of the first post 120. A second foot 150 extends the second-distance 117 perpendicularly from the second-lower edge 132 of the second post 130. A first-bracing member 141 joins the first post 120 to the first foot 140. A second-bracing member 151 joins the second post 130 to the second foot 150. At least one hinge 170 mechanically couples the first post 120 to the substantially rectangular sheet 110 and, the second post 130 to the substantially rectangular sheet 110. The first foot 140 and second foot 150 include apertures 101 for securing the collapsible barrier 100 to a surface.

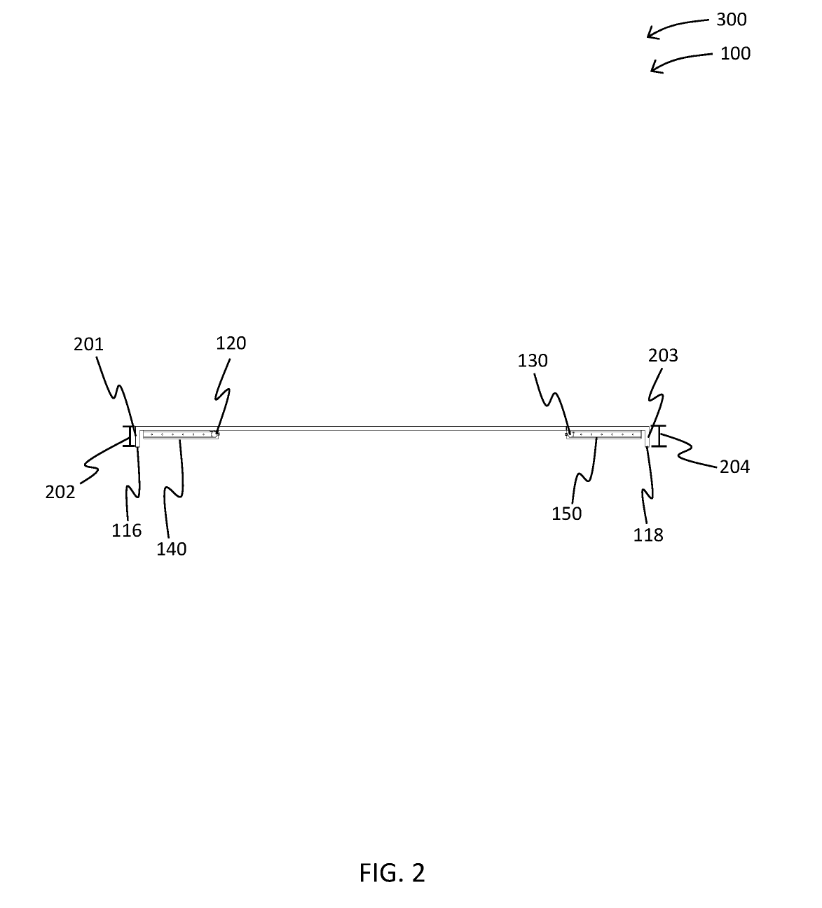

Referring now to FIG. 2 showing the collapsible barrier 100 of FIG. 1 in a ‘stowed’ condition 300, according to an embodiment of the present disclosure. As above, the collapsible barrier 100 may include a first-normal plane 201; the first-normal plane 201 extending a first-planar distance 202 perpendicularly along the first-vertical edge 116. The first post 120 may be pivotably connected to the substantially rectangular sheet 110. The first post 120 may be configured to pivot towards the first-vertical edge 116 allowing the first foot to be aligned parallel with the substantially rectangular sheet 110. As illustrated, the first foot 120 may be configured to fit parallel to the substantially rectangular sheet 110. The first-planar distance 202 may be sized such that that first-normal plane 201 extends past the first foot 120 when the first foot 120 is aligned parallel to the substantially rectangular sheet 110. A second-normal plane 203 extends a second-planar distance 204 perpendicularly along the second-vertical edge 118. The second post 130 may be pivotably connected to the substantially rectangular sheet 110. The second post 130 may be configured to pivot towards the second-vertical edge 118 allowing the second foot to be aligned parallel with the substantially rectangular sheet 110. As illustrated, the second foot 150 may be configured to fit parallel to the substantially rectangular sheet 110. The second-planar distance 204 may be sized such that the second-normal plane 203 extends past the second foot 150 when the second foot 150 is aligned parallel to the substantially rectangular sheet 110.

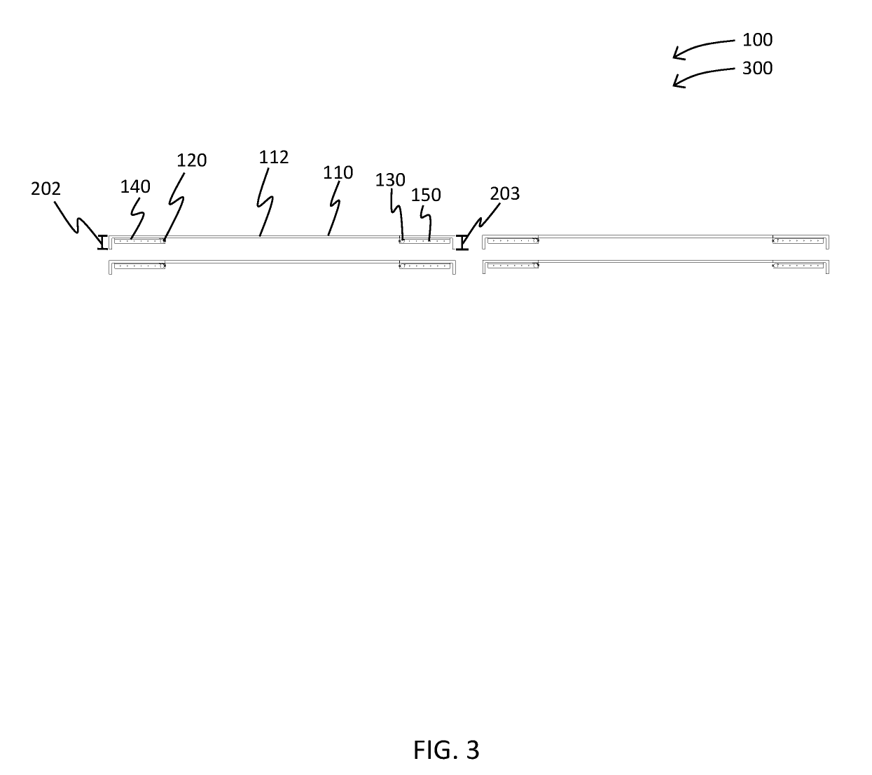

Referring now to FIG. 3 showing a top view of the collapsible barrier 100 of FIG. 1 in a ‘stowed’ condition, according to an embodiment of the present disclosure. As illustrated, a plurality of a collapsible barrier 100 may be in a stowed 300 condition. The stowed condition 300 conceptually is defined when the first foot 140 and the second foot 150 are aligned parallel with the substantially rectangular sheet 110. The collapsible barrier 100 may be configured to be stacked. The collapsible barrier may be made of a light-weight material allowing for ease of transport. As shown, the first-planar 202 distance and the second-planar 203 distance are much shorter than the upper-horizontal edge 112, the design allows for ease of storage.

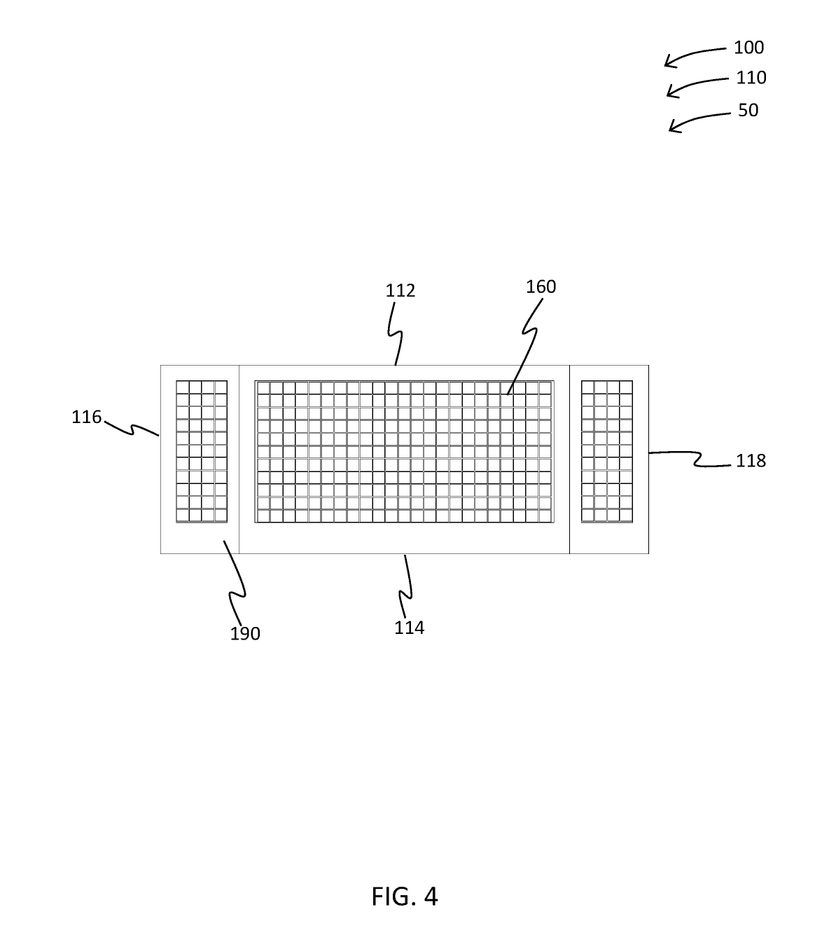

FIG. 4 is a front view of the collapsible barrier 100 of FIG. 1 during an ‘in-use’ condition 50, according to an embodiment of the present disclosure. As illustrated the collapsible barrier 100 may include a toe-board 190 disposed along the lower-horizontal edge 114. The toe-board 190 may further be integrated into the collapsible barrier 100 by circumscribing the perimeter of the substantially rectangular sheet 110. The toe-board 190 may be disposed along the first-vertical edge 116, the second-vertical edge 118 and the lower-horizontal edge 114 and anywhere therebetween as necessary. The toe-board 190 may comprise a light-weight material.

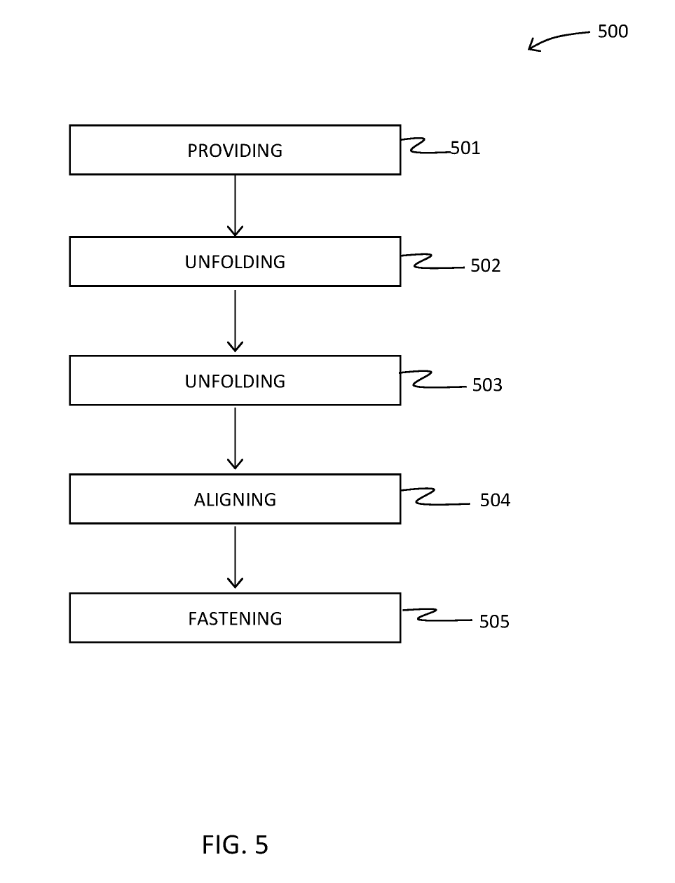

FIG. 5 is a flow diagram illustrating a method for collapsible barrier installation 500, according to an embodiment of the present disclosure. In particular, the method for collapsible barrier installation 500 may include one or more components or features of the collapsible barrier 100 as described above. As illustrated, the method for collapsible barrier installation 500 may include the steps of: step one 501, providing a collapsible barrier 100, the collapsible barrier 100 comprising a substantially rectangular sheet 110, the substantially rectangular sheet 110 comprising an upper-horizontal edge 112, a lower-horizontal edge 114, a first-vertical edge 116, a second-vertical edge 118; a metallic webbing 160, the metallic webbing 160 integrated with the substantially rectangular sheet 110 to provide suitable strength and load bearing capabilities; first post 120, the first post 120 having a first-upper edge 121 and a first-lower edge 122, the first post 120 disposed a first-distance 115 from the first-vertical edge 116; a second post 130, the second post 130 having a second-upper edge 131 and a second-lower edge 132, the second post 130 disposed a second-distance 117 from the second-vertical edge 118; a first foot 140, the first foot 140 extending the first-distance 114 perpendicularly from the first-lower edge 122 of the first post 120; a second foot 150, the second foot 150 extending the second-distance 117 perpendicularly from the second-lower edge 132 of the second post 150; a first-bracing member 141, the first-bracing 141 member joining the first post 120 to the first foot 140; a second-bracing member 151, the second-bracing 151 member joining the second post 130 to the second foot 150; at least one hinge 170, the at least one hinge 170 mechanically coupling, the first post 120 to the substantially rectangular sheet 110, the second post 130 to the substantially rectangular sheet 110; a first-normal plane 201, the first-normal plane 201 extending a first-planar distance 202 perpendicularly along the first-vertical edge 116; a second-normal plane 203, the second-normal plane 203 extending a second-planar distance 204 perpendicularly along the second-vertical edge 118; wherein the first post 120 and the second post 130 are aligned parallel to the first-vertical edge 116 and the second-vertical edge 118; wherein the first-distance 114 and the second-distance 117 are substantially equal; wherein the collapsible barrier 100 is configured to be stacked; step two 502, unfolding the first foot 140 pivotably with the first post 120 until the first foot 140 is perpendicular to the substantially rectangular sheet 110; step three 503, unfolding the second foot 150 pivotably with the second post 130 until the second foot 150 is perpendicular to the substantially rectangular sheet 110; step four 504, aligning apertures 101 of the first foot 140 and the second foot 150 for mechanically affixing to a surface; step five 505, fastening the first foot 140 and the second foot 150 to a surface.

It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for collapsible barrier installation, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A collapsible barrier, the collapsible barrier comprising:
a substantially rectangular sheet, the substantially rectangular sheet comprising an upper-horizontal edge, a lower-horizontal edge, a first-vertical edge, a second-vertical edge;
a metallic webbing, the metallic webbing integrated with the substantially rectangular sheet to provide suitable strength and load bearing capabilities;
a first post, the first post having a first-upper edge and a first-lower edge, the first post disposed a first-distance from the first-vertical edge;
a second post, the second post having a second-upper edge and a second-lower edge, the second post disposed a second-distance from the second-vertical edge;
a first foot, the first foot extending the first-distance perpendicularly from the first-lower edge of the first post;
a second foot, the second foot extending the second-distance perpendicularly from the second-lower edge of the second post;
a first-bracing member, the first-bracing member joining the first post to the first foot;
a second-bracing member, the second-bracing member joining the second post to the second foot;
at least one hinge, the at least one hinge mechanically coupling, the first post to the substantially rectangular sheet, the second post to the substantially rectangular sheet;
a first-normal plane, the first-normal plane extending a first-planar distance perpendicularly along the first-vertical edge;
a second-normal plane, the second-normal plane extending a second-planar distance perpendicularly along the second-vertical edge;
wherein the first post and the second post are aligned parallel to the first-vertical edge and the second-vertical edge;
wherein the first-distance and the second-distance are substantially equal; and
wherein the collapsible barrier is configured to be stacked.

2. The collapsible barrier of claim 1, wherein the first post is pivotably connected to the substantially rectangular sheet.

3. The collapsible barrier of claim 1, wherein the second post is pivotably connected to the substantially rectangular sheet.

4. The collapsible barrier of claim 1, wherein the first post is configured to pivot toward the first-vertical edge.

5. The collapsible barrier of claim 1, wherein the second post is configured to pivot towards the second-vertical edge.

6. The collapsible barrier of claim 1, wherein the upper-horizontal edge and the lower-horizontal edge are longer than the first-vertical edge and the second-vertical edge.

7. The collapsible barrier of claim 1, wherein the upper-horizontal edge and the lower-horizontal edge are substantially equal.

8. The collapsible barrier of claim 1, wherein the upper-horizontal edge and the lower-horizontal edge are approximately 10-feet.

9. The collapsible barrier of claim 1, wherein the first-distance and the second-distance are approximately 1.5-feet.

10. The collapsible barrier of claim 1, wherein the first foot is configured to fit parallel to the substantially rectangular sheet.

11. The collapsible barrier of claim 1, wherein the second foot is configured to fit parallel to the substantially rectangular sheet.

12. The collapsible barrier of claim 1, wherein the first-planar distance is sized such that the first-normal plane extends past the first foot when the first foot is aligned parallel to the substantially rectangular sheet.

13. The collapsible barrier of claim 1, wherein the second-planar distance is sized such that the second-normal plane extends past the second foot when the second foot is aligned parallel to the substantially rectangular sheet.

14. The collapsible barrier of claim 1, wherein the collapsible barrier is made of light-weight material.

15. The collapsible barrier of claim 1, wherein the first foot and second foot include apertures for securing the collapsible barrier to a surface.

16. The collapsible barrier of claim 1, wherein the collapsible barrier has a toe-board disposed along the lower-horizontal edge.

17. A collapsible barrier, the collapsible barrier comprising:
a substantially rectangular sheet, the substantially rectangular sheet comprising an upper-horizontal edge, a lower-horizontal edge, a first-vertical edge, a second-vertical edge;
a metallic webbing, the metallic webbing integrated with the substantially rectangular sheet to provide suitable strength and load bearing capabilities;
a first post, the first post having a first-upper edge and a first-lower edge, the first post disposed a first-distance from the first-vertical edge;
a second post, the second post having a second-upper edge and a second-lower edge, the second post disposed a second-distance from the second-vertical edge;
a first foot, the first foot extending the first-distance perpendicularly from the first-lower edge of the first post;
a second foot, the second foot extending the second-distance perpendicularly from the second-lower edge of the second post;
a first-bracing member, the first-bracing member joining the first post to the first foot;
a second-bracing member, the second-bracing member joining the second post to the second foot;
at least one hinge, the at least one hinge mechanically coupling, the first post to the substantially rectangular sheet, the second post to the substantially rectangular sheet;
a first-normal plane, the first-normal plane extending a first-planar distance perpendicularly along the first-vertical edge;
a second-normal plane, the second-normal plane extending a second-planar distance perpendicularly along the second-vertical edge;
wherein the first post and the second post are aligned parallel to the first-vertical edge and the second-vertical edge;
wherein the first-distance and the second-distance are substantially equal;
wherein the collapsible barrier is configured to be stacked;
wherein the first post is pivotably connected to the substantially rectangular sheet;
wherein the second post is pivotably connected to the substantially rectangular sheet;
wherein the first post is configured to pivot toward the first-vertical edge;
wherein the second post is configured to pivot towards the second-vertical edge;
wherein the upper-horizontal edge and the lower-horizontal edge are longer than the first-vertical edge and the second-vertical edge;
wherein the upper-horizontal edge and the lower-horizontal edge are substantially equal;
wherein the upper-horizontal edge and the lower-horizontal edge are approximately 10-feet;
wherein the first-distance and the second-distance are approximately 1.5-feet;
wherein the first foot is configured to fit parallel to the substantially rectangular sheet;
wherein the second foot is configured to fit parallel to the substantially rectangular sheet;
wherein the first-planar distance is sized such that the first-normal plane extends past the first foot when the first foot is aligned parallel to the substantially rectangular sheet;
wherein the second-planar distance is sized such that the second-normal plane extends past the second foot when the second foot is aligned parallel to the substantially rectangular sheet;
wherein the collapsible barrier is made of light-weight material;
wherein the first foot and second foot include apertures for securing the collapsible barrier to a surface; and
wherein the collapsible barrier has a toe-board disposed along the lower-horizontal edge.

18. A method of collapsible barrier installation, the method comprising the steps of:
providing a collapsible barrier;
unfolding a first foot pivotably with a first pole until the first foot is perpendicular to a substantially rectangular sheet;
unfolding a second foot pivotably with a second pole until the second foot is perpendicular to the substantially rectangular sheet;
aligning apertures of the first foot and the second foot for mechanically affixing to a surface; and
fastening the first foot and the second foot to a surface.
